(19) United States
(12) Patent Application Publication
(10) Pub. No.: US 2024/0031382 A1
(43) Pub. Date: Jan. 25, 2024

(54) IN-VEHICLE APPARATUS, FRAUD DETECTION METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Fumiya ISHIKAWA, Yokkaichi-shi, Mie (JP)

(21) Appl. No.: 18/256,564

(22) PCT Filed: Nov. 24, 2021
(86) PCT No.: PCT/JP2021/042939

§ 371 Date: Jun. 8, 2023

(30) Foreign Application Priority Data
Dec. 10, 2020 (JP) 2020-205345

(51) Int. Cl. H04L 9/40; H04L 12/40

(52) U.S. Cl. CPC H04L 63/1416; H04L 63/1466; H04L 12/40104; H04L 2012/40215

(57) ABSTRACT

An in-vehicle apparatus is mounted in a vehicle and detects fraudulence in a message transmitted by an in-vehicle network. The in-vehicle apparatus includes a control unit that controls a process related to detection of a fraudulence in the message. The control unit provisionally detects whether a plurality of signals included in the acquired message are fraudulent. The control unit determines whether a target signal out of the plurality of signals including a signal provisionally detected as being fraudulent has a fail value. If the target signal has the fail value, the control unit detects whether the target signal included in the message is fraudulent, based on the signals other than the target signal out of the plurality of signals included in the message.

### CROSS-REFERENCE TO RELATED APPLICATIONS

This application is the U.S. national stage of PCT/JP2021/042939 filed on Nov. 24, 2021, which claims priority of Japanese Patent Application No. JP 2020-205345 filed on Dec. 10, 2020, the contents of which are incorporated herein.

### TECHNICAL FIELD

The present disclosure relates to an in-vehicle apparatus, a fraud detection method, and a computer program.

### BACKGROUND

Vehicles are equipped with a plurality of in-vehicle electronic control units (ECUs) for controlling in-vehicle devices. These in-vehicle ECUs are communicably connected to each other via an in-vehicle network to mutually transmit and receive data via an in-vehicle apparatus.

In an in-vehicle network, there is the threat of an attacker transmitting improper data to the in-vehicle network to fraudulently control the vehicle, via an in-vehicle ECU or the like that has the function of communicating with external communication devices. Thus, a fraud detection method for detecting fraudulence in an in-vehicle network has been proposed (for example, refer to JP 2020-102886A).

In a conventional method, there is room for improvement in the accuracy of fraud detection.

An object of the present disclosure is to provide an in-vehicle apparatus and the like that improve the accuracy of fraud detection in an in-vehicle network.

### SUMMARY

An in-vehicle apparatus according to an aspect of the present disclosure is an in-vehicle apparatus that is mounted in a vehicle and detects fraudulence in a message transmitted to an in-vehicle network. The in-vehicle apparatus includes a control unit that controls a process related to detection of fraudulence in the message. The control unit provisionally detects whether a plurality of signals included in the acquired message are fraudulent, and determines whether a target signal out of the plurality of signals including a signal provisionally detected as being fraudulent has a fail value. If the target signal has the fail value, the control unit detects the fraudulence in the target signal included in the message, based on the signal other than the target signal out of the plurality of signals included in the message.

### Advantageous Effects

According to an aspect of the present disclosure, it is possible to improve the accuracy of fraud detection in an in-vehicle network.

### BRIEF DESCRIPTION OF DRAWINGS

FIG. 1 is a schematic diagram showing a configuration of an in-vehicle system in a first embodiment.

FIG. 2 is a block diagram showing a configuration of an in-vehicle apparatus and the like according to the first embodiment.

FIG. 3 is a diagram for describing a mode of a data frame in a message.

FIG. 4 is a diagram for describing a record layout of a fail value DB.

FIG. 5 is an explanatory diagram describing changes in a signal included in a message.

FIG. 6 is a conceptual diagram showing first detection results and second detection results.

FIG. 7 is a flowchart of a procedure of a detection process executed by the in-vehicle apparatus in the first embodiment.

FIG. 8 is a conceptual diagram showing first detection results and second detection results in a second embodiment.

FIG. 9 is a flowchart of a procedure of a detection process executed by an in-vehicle apparatus in the second embodiment.

### BRIEF DESCRIPTION OF PREFERRED EMBODIMENTS

First, embodiments of the present disclosure will be listed and described. At least some of the embodiments described below may be combined as desired.

An in-vehicle apparatus according to an aspect of the present disclosure is an in-vehicle apparatus that is mounted in a vehicle and detects fraudulence in a message transmitted to an in-vehicle network. The in-vehicle apparatus includes a control unit that controls a process related to detection of fraudulence in the message. The control unit provisionally detects whether a plurality of signals included in the acquired message are fraudulent. The control unit determines whether or not a target signal out of the plurality of signals including a signal provisionally detected as fraudulent has a fail value. If the target signal has the fail value, the control unit detects whether the target signal included in the message is fraudulent, based on the signals other than the target signal out of the plurality of signals included in the message.

According to the present aspect, the in-vehicle apparatus executes a provisional detection process (first detection process) for provisionally detecting fraudulence in the message including the plurality of signals acquired via the in-vehicle network. If fraudulence is provisionally detected in the provisional detection process and the target signal that is a detection target out of the plurality of signals includes a fail value, the in-vehicle apparatus executes a further detection process (second detection process) on the target signal. The further detection process is performed according to a detection method different from the provisional detection process, and corresponds to the main detection process with respect to the provisional detection process, for example. Executing the two detection processes on the signals in the message transmitted in the in-vehicle network prevents erroneous detection and failure to find a fraudulent value, and improves the detection accuracy. The second detection process is performed based on information regarding the signals (surrounding signals) other than the target signal. Therefore, it is possible to properly detect fraudulence in the target signal based on the states of the signals surrounding the target signal. For example, it is possible to accurately detect fraudulent rewriting of data including the surrounding signals, which is assumed to be a virus attack from the outside of the vehicle.

An in-vehicle apparatus according to an aspect of the present disclosure determines whether each of the signals other than the target signal has the fail value, and if the number of signals having the fail value other than the target signal is less than a first predetermined value, the in-vehicle apparatus detects the target signal as being normal.

According to the present aspect, whether the target signal is fraudulent is determined based on the number of surrounding signals having the fail value. If it is determined that the target signal has the fail value based on the result of determination on whether each of the plurality of surrounding signals has the fail value, and if the number of surrounding signals having the fail values is less than the threshold, the in-vehicle apparatus detects the fail value of the target signal as being normal. Holistically evaluating the target signal using the states of the surrounding signals enables more accurate fraud detection than in the case of evaluating the target signal alone.

An in-vehicle apparatus according to an aspect of the present disclosure determines whether each of the signals other than the target signal has the fail value, and if the number of signals having the fail value other than the target signal is less than half the total number of the signals other than the target signal, the in-vehicle apparatus detects the target signal as normal.

According to the present aspect, if it is determined that the target signal has the fail value based on the result of determination on whether or not each of the plurality of surrounding signals has the fail value, and if the number of surrounding signals having the fail value out of the plurality of surrounding signals is less than half, the in-vehicle apparatus detects the fail value of the target signal as being normal. In general, it is unlikely that more than half of signals included in a message have a fail value. Therefore, detecting the target signal as being fraudulent if the ratio of the fail values is high makes it possible to accurately detect a fraudulent message disguised as the fail value.

An in-vehicle apparatus according to an aspect of the present disclosure detects the target signal as being normal if the number of signals provisionally detected as normal out of the plurality of signals is greater than or equal to a second predetermined value.

According to the present aspect, whether the target signal is fraudulent is determined based on the provisional detection results (first detection results) of the surrounding signals. If it is determined that the target signal has the fail value based on the provisional detection results of the plurality of surrounding signals, and if the number of surrounding signals provisionally detected as normal out of the plurality of surrounding signals is greater than or equal to the threshold, the in-vehicle apparatus detects the fail value of the target signal as being normal. Holistically evaluating the target signal using the provisional detection results of the surrounding signals improves the detection accuracy as compared with that in the case of using the target signal alone.

An in-vehicle apparatus according to an aspect of the present disclosure provisionally detects whether the plurality of signals are fraudulent to detect the target signal as being normal if the in-vehicle apparatus acquires the provisional detection result indicating that all of the signals other than the target signal out of the plurality of signals are normal.

According to the present aspect, if it is determined that the target signal has the fail value based on the provisional detection results of the plurality of surrounding signals, and if the provisional detection results of all the plurality of surrounding signals are normal, the in-vehicle apparatus detects the fail value of the target signal as being normal. Employing the provisional detection results of all the surrounding signals only if the provisional detection results are normal prevents the employment of erroneous provisional detection results of the surrounding signals.

In an in-vehicle apparatus according to an aspect of the present disclosure, the in-vehicle network is provided with a plurality of communication lines, and if the target signal included in the message transmitted via any one of the plurality of communication lines has the fail value, the in-vehicle apparatus detects whether the target signal in the message is fraudulent based on a signal in another message transmitted via the any one of the communication lines.

According to the present aspect, the detection process can be executed in communication line (bus) units in the in-vehicle network. Therefore, it is possible to accurately detect fraudulence in bus-by-bus attacks.

In an in-vehicle apparatus according to an aspect of the present disclosure, the fail value is a value for executing a predetermined fail-safe process.

According to the present aspect, if the target signal has a value for executing the predetermined fail-safe process, the second detection process is executed. In many cases, the value for executing the predetermined fail-safe process is a value different from the normally used value and the signal having the value is likely to be determined as being a fraudulent signal. In the case of including such a fail value, performing the second detection process reduces erroneous detection of a normal fail value as being fraudulent so that the fail-safe process can be appropriately executed.

In an in-vehicle apparatus according to an aspect of the present disclosure, the message is in conformity with Controller Area Network (CAN) protocol.

According to the present aspect, it is possible to apply the detection process to the message in conformity with the CAN protocol that is widely employed in communications in conventional in-vehicle networks, thus accurately detecting fraud.

A fraud detection method according to an aspect of the present disclosure, includes: provisionally detecting whether a plurality of signals included in an acquired message transmitted to an in-vehicle network are fraudulent, determining whether a target signal out of the plurality of signals including a signal provisionally detected as fraudulent has a fail value, and if the target signal has the fail value, detecting whether the target signal included in the message is fraudulent, based on the signals other than the target signal out of the plurality of signals included in the message.

According to the present aspect, it is possible to improve the accuracy of fraud detection in the in-vehicle network.

A computer program according to an aspect of the present disclosure causes a computer to execute: provisionally detecting whether a plurality of signals included in an acquired message transmitted to an in-vehicle network are fraudulent, determining whether a target signal out of the plurality of signals including a signal provisionally detected as fraudulent has a fail value, and if the target signal has the fail value, detecting whether the target signal included in the message is fraudulent, based on the signals other than the target signal out of the plurality of signals included in the message.

According to the present aspect, it is possible to improve the accuracy of fraud detection in the in-vehicle network.

### DETAILS OF EMBODIMENTS OF PRESENT DISCLOSURE

The present disclosure will be described in detail with reference to the drawings illustrating embodiments of the present disclosure. It should be noted that the present disclosure is not limited to these examples, but rather is indicated by the scope of claims, and is intended to include all modifications within a meaning and scope equivalent to the scope of claims.

### First Embodiment

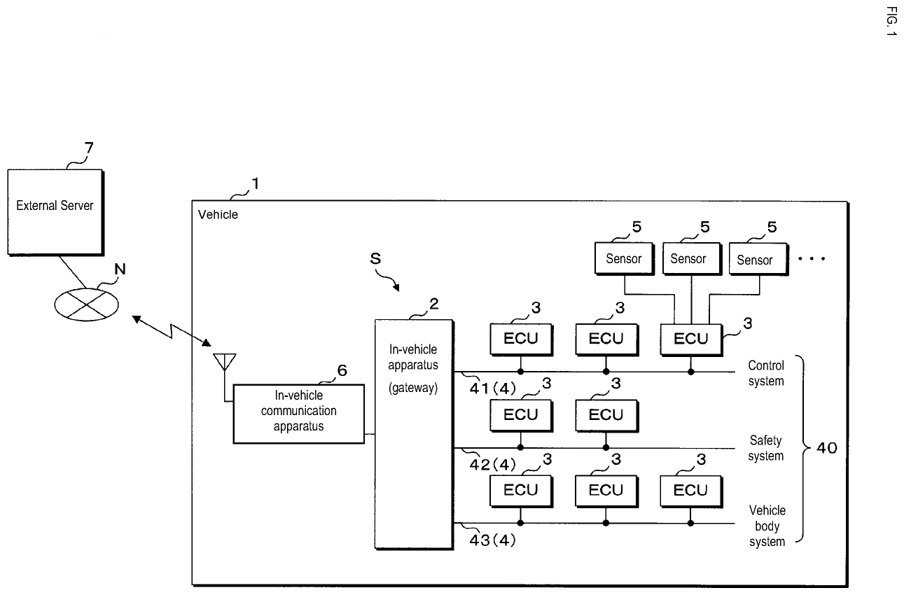

FIG. 1 is a schematic view of a configuration of an in-vehicle system S in a first embodiment. The in-vehicle system S includes an in-vehicle apparatus 2 mounted in a vehicle 1 and a plurality of in-vehicle electronic control units (hereinafter, simply called ECUs). The in-vehicle apparatus 2 is connected to a plurality of communication lines 41 to 43. The in-vehicle apparatus 2 is communicably connected to the ECUs 3 via the communication lines 41 to 43 that support a predetermined communication protocol. The in-vehicle apparatus 2 relays messages transmitted and received among the plurality of ECUs 3 and detects fraudulent messages.

The communication lines 41 to 43 are provided in correspondence with systems such as a control system, a safety system, and a vehicle body system, for example. The plurality of communication lines 41 to 43 constitute an in-vehicle network 40. In the following description, when there is no need to differentiate the communication lines 41 to 43 from one another, the communication lines will simply be referred to as communication lines 4.

The vehicle 1 is equipped with the plurality of ECUs 3 for controlling the in-vehicle apparatus 2, an external communication apparatus 6, and various in-vehicle devices. Each ECU 3 is connected to one of the plurality of communication lines 41 to 43 routed in the vehicle 1 on a system-by-system basis, in accordance with the function of the own ECU 3 (for example, the control system, the safety system, the vehicle body system, or the like). The ECUs 3 transmit and receive data (messages) via the connected communication lines 41 to 43. In the illustrated example, three ECUs 3 are connected to the communication line 41 of the control system and three ECUs 3 are connected to the communication line 43 of the safety system, and two ECUs 3 are connected to the communication line 42 of the vehicle body system.

The ECUs 3 are connected to a plurality of sensors 5, for example, and output data including output values from the sensors 5 via the communication lines 41 to 43. The communication lines 41 to 43 are connected to the in-vehicle apparatus 2. The in-vehicle apparatus 2 relays the communications among the plurality of communication lines 41 to 43. This enables each of the ECUs 3 to mutually transmit and receive data to and from the other ECUs 3 and the in-vehicle apparatus 2 via the communication lines 41 to 43 and the in-vehicle apparatus 2. The ECUs 3 may be connected to an actuator of an engine or brake, for example.

The in-vehicle apparatus 2 collectively controls the segments of the systems constituted by the plurality of communication lines 4 connected to the in-vehicle apparatus 2, and relays the communications among the ECUs 3 in these segments. The in-vehicle apparatus 2 is a gateway or Ethernet (registered trademark) switch, for example. Each of the communication lines 41 to 43 corresponds to a bus in the corresponding segment. The in-vehicle apparatus 2 may be formed as one functional unit such as a vehicle body ECU 3 that controls the entire vehicle 1, an autonomous driving ECU 3 that controls autonomous driving, or an integrated ECU 3 that is formed of a vehicle computer, for example.

In the first embodiment, the messages transmitted and received via the in-vehicle network 40 and the communication lines 4 comply with the communication protocol of Controller Area Network (CAN) (registered trademark). The communication protocol is not limited to CAN but may be Ethernet (registered trademark), Local Interconnect Network (LIN), or the like, for example.

In the in-vehicle system S according to the first embodiment, the in-vehicle apparatus 2 is communicably connected to the external communication apparatus 6 via a harness such as a serial cable. The external communication apparatus 6 is a communication apparatus for performing wireless communication using a protocol of mobile communication such as 3G, LTE, 4G, 5G, or Wi-Fi. The external communication apparatus 6 transmits and receives data to and from an external server 7 via an antenna provided on the external communication apparatus 6. The in-vehicle apparatus 2 can communicate with the external server 7 installed outside the vehicle 1 via the external communication apparatus 6. The external communication apparatus 6 may be contained in the in-vehicle apparatus 2 as a component of the in-vehicle apparatus 2.

The external server 7 is a computer such as a server connected to an external network N such as the Internet or a public circuit network. The external server 7 manages and stores programs and data to be executed by the ECUs 3 mounted in the vehicle 1, for example. The in-vehicle apparatus 2 acquires programs and data transmitted from the external server 7 through wireless communication, and transmits the acquired programs and data to the target ECUs 3 via the communication lines 4 to which the target ECUs 3 are connected.

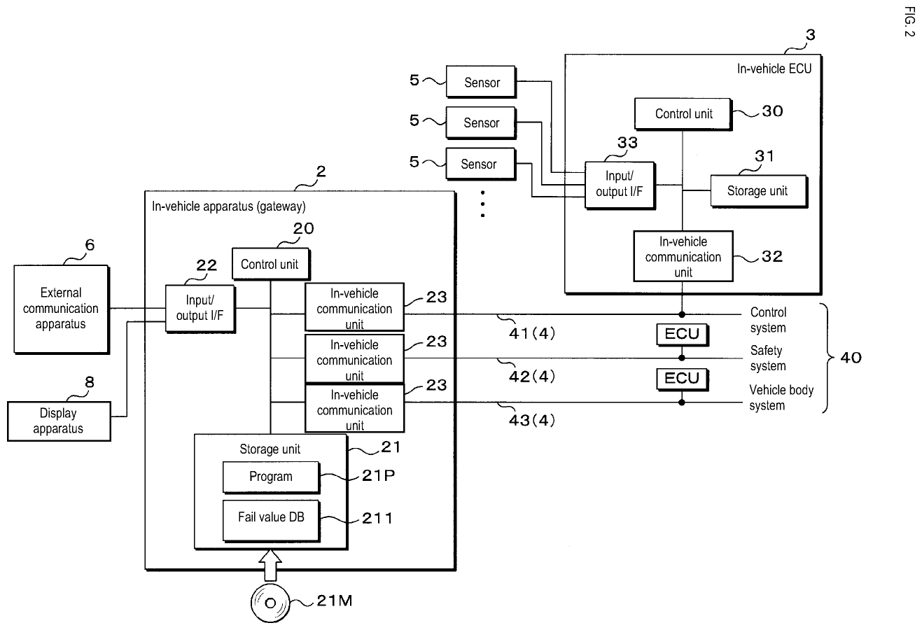

FIG. 2 is a block diagram showing a configuration of the in-vehicle apparatus 2 and the like according to the first embodiment. The in-vehicle apparatus 2 includes a control unit 20, a storage unit 21, an input/output I/F 22, in-vehicle communication unit 23, and the like.

The control unit 20 includes a central processing unit (CPU), a micro processing unit (MPU), or the like. The control unit 20 uses built-in memories such as a read only memory (ROM) and a random access memory (RAM) to control the components and perform various control processes and computing processes. The control unit 20 functions as the in-vehicle apparatus of the present disclosure that executes a process related to fraud detection in communication by reading out and executing a program 21P stored in the ROM or the storage unit 21.

The storage unit 21 includes a non-volatile memory such as an electrically erasable programmable ROM (EEPROM) or a flash memory. The storage unit 21 stores programs including the program 21P to be executed by the control unit 20, data necessary for executing the programs, and the like. The program 21P stored in the storage unit 21 may be recorded on a recording medium 21M in a computer-readable manner. The storage unit 21 stores the program 21P read out from the recording medium 21M by a reading device (not shown). The program 21P may be downloaded from an external computer (not shown) connected to a communication network (not shown) and stored in the storage unit 21.

The storage unit 21 also stores a fail value data base (DB) 211 in which fail values for executing a fraud detection process are stored. The fail value DB 211 is described below. The storage unit 21 may store relay route information (a routing table) that is used to perform a relay process for communication among the ECUs 3 or communication between the ECUs 3 and the external server 7.

The input/output I/F 22 includes a communication interface for serial communication, for example. The input/output I/F 22 is communicably connected to the external communication apparatus 6 and a display apparatus 8. The display apparatus 8 is a human machine interface (HMI) apparatus such as a car navigation display, for example. The display apparatus 8 displays data or information output from the control unit 20 via the input/output I/F 22. The connection mode between the in-vehicle apparatus 2 and the display apparatus 8 is not limited to connection via the input/output I/F 22. The in-vehicle apparatus 2 and the display apparatus 8 may be connected to each other via the in-vehicle network 40.

The in-vehicle communication unit 23 includes a communication interface for communication with the ECUs 3 via the in-vehicle network 40. The in-vehicle communication unit 23 is connected to the communication line 4 to transmit and receive data according to a predetermined communication protocol. In the first embodiment, the in-vehicle communication unit 23 is a CAN transceiver, which supports CAN messages transmitted via the communication lines 4 that are CAN buses. The control unit 20 mutually communicates with in-vehicle devices such as the ECUs 3 or other in-vehicle apparatuses connected to the in-vehicle network 40, via the in-vehicle communication unit 23.

The in-vehicle apparatus 2 includes a plurality of in-vehicle communication units 23. Each of the in-vehicle communication units 23 is connected to one of the communication lines 41 to 43 constituting the in-vehicle network 40. The plurality of in-vehicle communication units 23 may be provided in this manner to divide the in-vehicle network 40 into a plurality of segments and the ECUs 3 may be connected to the corresponding segments in accordance with the functions of the own apparatus.

Each ECU 3 includes a control unit 30, a storage unit 31, an in-vehicle communication unit 32, an input/output I/F 33, and the like. The control unit 30 includes a CPU or an MPU. The control unit 30 uses a memory such as a built-in ROM or RAM to control the components. The storage unit 31 includes a non-volatile memory such as an EEPROM or a flash memory. The control unit 30 of each ECU controls the in-vehicle devices including the ECU 3 or actuators by reading out and executing programs stored in the ROM or the storage unit 31. The in-vehicle communication unit 32 includes a communication interface for communication with the in-vehicle apparatus 2 via the in-vehicle network 40. The input/output I/F 33 is connected to the plurality of sensors 5, for example. The input/output I/F 33 acquires output values from the plurality of sensors 5 and outputs the same to the control unit 30. The control unit 30 outputs messages including signals obtained by, for example, digitally converting the acquired output values, to the communication lines 4 via the in-vehicle communication unit 32.

The control unit 20 of the in-vehicle apparatus 2 receives the messages transmitted from the ECUs 3 connected to the communication lines 4 or transmits messages to the ECUs 3, and functions as a CAN controller, for example. The control unit 20 refers to a message identifier such as a CAN-ID included in a received message, and specifies the in-vehicle communication unit 23 corresponding to the segment serving as a transmission destination, based on the referred message identifier and the relay route information or the like stored in the storage unit 21. The control unit 20 functions as a CAN gateway that relays a message by transmitting the message received from the specified in-vehicle communication unit 23. The control unit 20 is described above as functioning as a CAN controller, but is not limited to this. The in-vehicle communication unit 23 may function as a CAN transceiver and a CAN controller.

The control unit 20 also functions as an intrusion detection system (IDS) that analyzes messages received via the in-vehicle network 40 to detect a fraudulent message. A fraudulent message is a message that is transmitted from a fraudulent ECU 3 such as an ECU 3 in an abnormal state due to a virus that has intruded from outside of the vehicle via the external communication apparatus 6 or the like or an ECU 3 replaced without authorization, for example. The control unit 20 may further function as an intrusion prevention system (IPS) that executes a preventive process such as shutdown of communication based on the detected content of a message. The control unit 20 may function as an intrusion detection and prevention system (IDPS). If the control unit 20 determines that the received message is a fraudulent message as described above, the control unit 20 may transmit information regarding the message identifier and the like included in the fraudulent message to the display apparatus 8 to display information on the display apparatus 8. Displaying the information on the display apparatus 8 makes it possible to notify the human operator of the vehicle 1 that the fraudulent message has been detected.

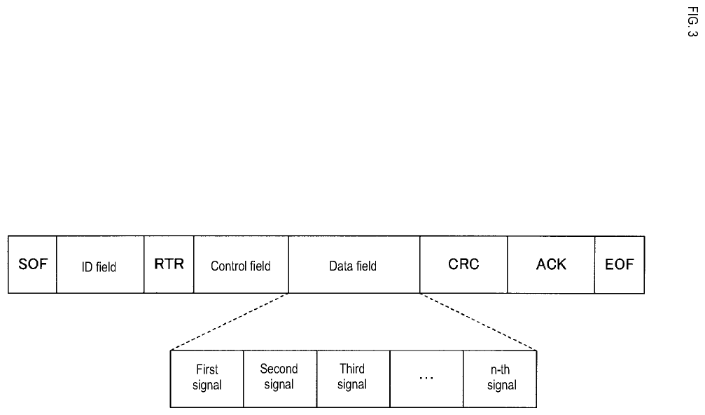

In the first embodiment, a message transmitted and received via the in-vehicle network 40 will be described. FIG. 3 is a diagram for describing a mode of a data frame in the message. In the first embodiment, as described above, messages are transmitted and received according to CAN protocol. The CAN protocol is a communication protocol that is prescribed by ISO11898 and the like. The frame types (frames) of a message transmitted and received are classified into a data frame, a remote frame, an error frame, and an overload frame. FIG. 3 illustrates a mode of a data frame among these frame types. The data frame is formed by fields such as Start Of Frame (SOF), an ID field, Remote Transmission Request (RTR), a control field, a data field, CRC, Acknowledgement (ACK), and End Of Frame (EOF). The ID field contains a message identifier (for example, CAN-ID) for identifying the content and transmission node of the message. The data field contains the data (signal) of the message transmitted. A description of the details of the other fields will be omitted.

The data field is made of 642 bits at most and can be set in lengths of 8 bit units. The data field includes a plurality of signals each made of a predetermined number of bits, in accordance with the content of the message. In the example of FIG. 3, the data field includes a first signal, a second signal, . . . , and an n-th signal, for a total of n signals. The method for data allocation is not prescribed under the CAN protocol and can be determined in the in-vehicle system S. The method for data allocation may be set in accordance with the vehicle type, the manufacturer (maker), or the like, for example. The signals stored in the data field include a vehicle-speed signal indicating a vehicle speed, an engine RPM signal indicating the RPM of the engine, a wheel speed signal indicating the wheel speed, and the like.

Each signal includes a valid value and a fail value. The valid value is a value used in data communication when the ECU 3 is normal. In the present embodiment, the fail value is a value used when an anomaly occurs in the vehicle 1 and a predetermined fail-safe process is executed on the entire vehicle 1 or a specific in-vehicle apparatus in the vehicle 1. The fail value is uniquely set for each signal type, based on the specifications of the manufacturer or the like. The fail value may be a specific value that is not used as a valid value. Each ECU 3 accepts output values from the plurality of sensors 5 that are connected to the own apparatus to detect the vehicle speed, the engine RPM, the wheel speed, and the like, and generates a message in which a plurality of valid values that make a notification regarding received accepted output values are stored in the data field. Each ECU 3 also generates a message in which the fail values are stored in the data field in response to an instruction for execution of a fail-safe process. The valid values are not limited to the values indicating the output values from the sensors 5.

A message transmitted from a normal ECU 3 includes a valid value or a fail value as a normal signal. That is, the message transmitted from the normal ECU 3 is a normal message including a normal signal. On the other hand, the message transmitted from a fraudulent ECU 3 includes a fraudulent value (fraudulent signal) such as a value disguised as a valid value or a fail value. That is, the message transmitted from a fraudulent ECU 3 is a fraudulent message including a fraudulent signal.

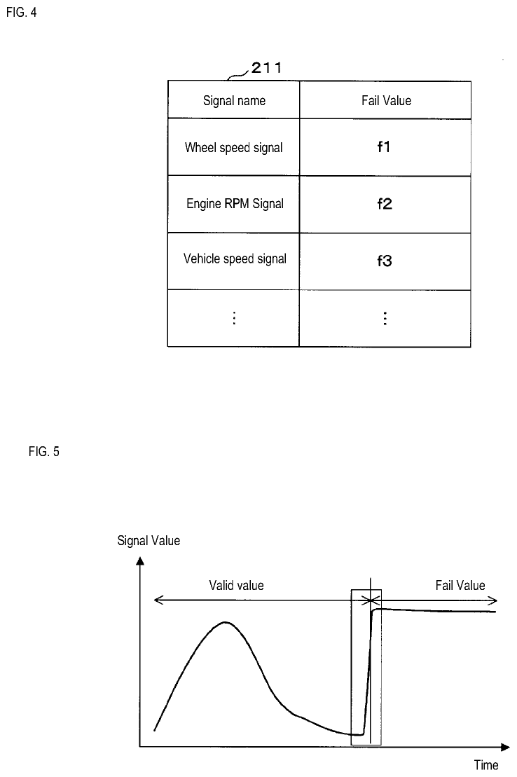

FIG. 4 is a diagram for describing a record layout of the fail value DB 211. The storage unit 21 of the in-vehicle apparatus 2 stores the fail value DB 211 in which fail values prescribed by signal type are stored. In the fail value DB 211, signal names and fail values are stored in association with each other, for example. The signal name is identification information for identifying the type of signal stored in the data field. The identification information is not limited to a signal name and may be a signal ID, for example. The fail values of signals identified by the identification information are stored in the fail value column. The fail values are not limited to a specific value and may be defined as values within a predetermined range. The storage unit 21 of the in-vehicle apparatus 2 acquires, in advance, information regarding the fail value corresponding to each signal through communication with the external server 7, for example, and stores the acquired information in the fail value DB 211. The control unit 20 of the in-vehicle apparatus 2 uses the fail value DB 211 to execute a detection process for detecting a fraudulent signal included in a message.

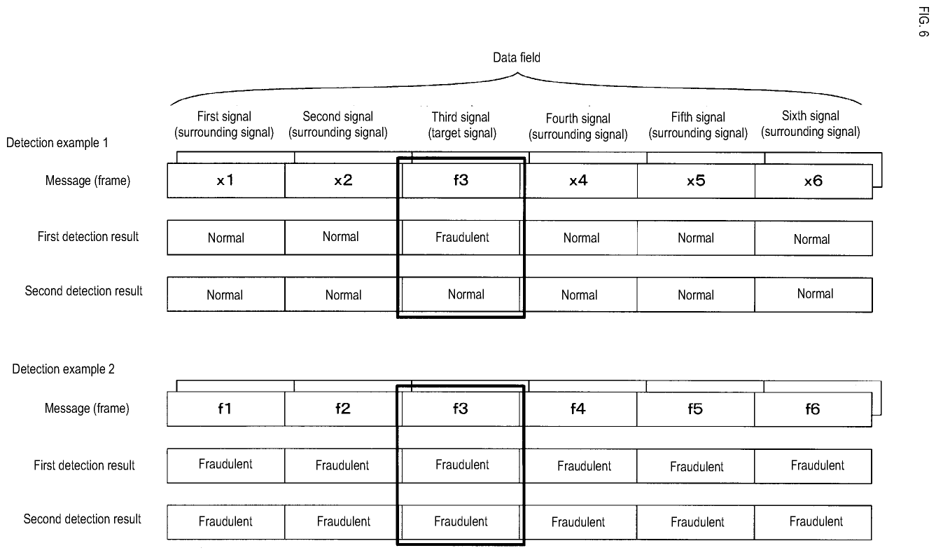

The fraud detection process executed by the in-vehicle apparatus 2 in the first embodiment will be described. The control unit 20 of the in-vehicle apparatus 2 detects a fraudulent message by determining whether or not the signals included in the message are normal based on the values and amounts of change in the signals, for example. The control unit 20 executes, as the fraudulent detection process, two detection processes, namely a first detection process and a second detection process. The first detection process corresponds to a provisional detection process. FIG. 5 is an explanatory diagram describing changes in a signal included in a message. FIG. 6 is a conceptual diagram showing first detection results and second detection results. Methods for the first detection process and second detection process will be described in detail with reference to FIGS. 5 and 6.

The graph in FIG. 5 is a graph showing time-series changes in a signal. The horizontal axis indicates time and the vertical axis indicates signal value. The signal value is a value indicating a vehicle speed signal, for example. The ECU 3 controlling the vehicle speed periodically acquires the speed of the vehicle from the speed sensor connected to the ECU 3, and transmits a message including a signal (valid value) for making a notification regarding the acquired speed via the communication lines 4. As shown on the left side of the graph in FIG. 5, when the ECU 3 is normal, the value of the signal indicating the vehicle speed increases from at a predetermined inclination, for example, and then decreases at a predetermined inclination. When the ECU 3 is normal, the inclination of the signal, that is, the amount of change in the signal per unit time falls within a normal range set for the vehicle speed signal (for example, a range defined by an upper limit value and a lower limit value). On the other hand, in a fraudulent message transmitted from a fraudulent ECU 3, the signal may change sharply. That is, the amount of change in the signal in the fraudulent message may exceed the threshold representing the normal amount of change. The in-vehicle apparatus 2 detects a fraudulent message by detecting such a fraudulent change in the signal.

As shown on the right side of FIG. 5, in the case of executing a predetermined fail-safe process, the signal (fail value) included in the message greatly differs from the signal at the normal time (valid value). In this case as well, the signal changes sharply. In a conventional IDS detection method, whether or not the signal is fraudulent is determined based on whether the amount of change in the signal is proper. Thus, even when the signal changes from a valid value to a fail value, there is a possibility that the fail value will be detected as being fraudulent due to the large change in the signal. In the present embodiment, whether or not the signal has a fail value is determined in order to detect that the change in the signal resulting from the fail value is proper.

Upon receiving a message from the ECU 3, the control unit 20 of the in-vehicle apparatus 2 first performs the first detection process. In the first detection process, based on the amounts of change in signals included in two consecutive messages of the same type, the control unit 20 determines whether each signal is normal. Specifically, from among messages acquired in the past, the control unit specifies a message (a previous message) that includes the same kind of data as the current message and is continuous with the current message on a time-series. The control unit 20 specifies the previous message based on the message identifier, time stamp, and the like stored in the ID field of the current message. The control unit 20 may specify a message with the same message identifier, for example, as a message including the same type of data.

The control unit 20 calculates the amounts of change in the signals per unit time, based on the difference between the signals included in the current message and the previous message. The control unit 20 refers to a table (not shown) that stores the normal range of amount of change or the normal maximum amount of change (threshold) by signal type to determine whether or not the calculated amounts of change in the signals fall within the normal range or are smaller than or equal to a threshold, thereby deriving a first detection result indicating whether each signal is fraudulent or not.

If the amount of change in a signal falls within the normal range, the control unit 20 derives a first detection result indicating that the signal is normal. On the other hand, if the amount of change in a signal does not fall within the normal range, the control unit 20 derives a first detection result indicating that the signal is fraudulent. The cases in which a signal does not fall within the normal range include the case in which the amount of change in a signal deviates from the normal range and the case in which the amount of change in a signal exceeds the threshold. The control unit 20 performs the above-described process on each of the signals included in the message. The above-described first detection process corresponds to a fraud detection process according to a conventional IDS function. The method of the first detection process is not limited to the above-described example.

If the control unit 20 derives the first detection result indicating that a signal is fraudulent in the first detection process, the control unit 20 performs a further detection process. Specifically, the control unit 20 determines whether or not a target signal included in the message has a fail value. If the target signal has a fail value, the control unit 20 performs the second detection process to detect whether the target signal is fraudulent.

In the present embodiment, the target signal means any one of a plurality of signals included in a message, which is a target of the second detection process. The target signal may be any one of the signals detected as being fraudulent in the first detection process. Which of the plurality of signals included in the message is to be the target signal can be set as appropriate. For example, in view of the safety of the vehicle 1, a high-priority signal may be set as a target signal, or the plurality of signals included in the message may be recursively processed as a target signal in a predetermined order.

The control unit 20 refers to the fail value DB 211 that stores fail values by signal type to determine whether or not the target signal included in the message has a fail value. If the target signal has a fail value, the control unit 20 performs the second detection process to detect whether the target signal is fraudulent using a determination method different from that in the first detection process. In the second detection process, the control unit 20 detects whether the target signal is fraudulent based on the information of surrounding signals. The surrounding signals refer to signals other than the target signal among the plurality of signals included in the same message.

The control unit 20 determines whether each of the surrounding signals has a fail value, in a manner similar to the determination performed on the target signal. The control unit 20 determines whether or not the target signal is normal by determining whether or not the number of surrounding signals having fail values is smaller than half the total number of the surrounding signals. If the number of surrounding signals having fail values is smaller than half the total number of surrounding signals, the control unit 20 determines that the target signal is normal and derives the second detection result indicating that the target signal is normal. If the number of surrounding signals having fail values is greater than or equal to half the total number of surrounding signals, the control unit 20 determines that the target signal is fraudulent and derives the second detection result indicating that the target signal is fraudulent.

Referring to FIG. 6, a method for deriving a second detection result that is based on the first detection result will be described in detail in reference to a detection example 1 and a detection example 2. In FIG. 6, an example is described in which the data field of a message (frame) includes first to sixth signals, a total of six signals, and the third signal is a vehicle speed signal that is the target signal.

In the detection example 1 on the upper side of FIG. 6, the third signal in the current message has a fail value. The five surrounding signals other than the third signal have valid values. The control unit 20 executes the first detection process based on the amounts of change in the signals in the current message and the previous message. As the first detection results, for example, the detection results indicating that the third signal is fraudulent and the surrounding signals are all normal are derived. As described above, if a signal included in the current message has a fail value and if a signal included in the previous message adjacent to the current message on the time-series has a valid value, the amount of change in the signals between the two messages is large. Therefore, the fail value of the third signal is determined as being fraudulent in the first detection process.

The control unit 20 executes the second detection process to determine whether or not the fail value of the third signal is fraudulent based on the number of fail values of the surrounding signals. In the detection example 1, all of the surrounding signals have valid values. That is, the number of surrounding signals having fail values is smaller than half the total number of the surrounding signals. Therefore, the second detection result indicating that the fail value of the third signal is normal is derived. In this manner, if most of the surrounding signals have normal valid values, it is estimated that the target signal has normal data and the change in the signal value resulting from the fail value is proper, and thus the target signal is determined as being normal.

In the detection example 2 on the lower side of FIG. 6, all of the signals in the current message have fail values. As the first detection result, for example, the detection result indicating that the signals are all fraudulent is derived. In the detection example 2, all of the surrounding signals have fail values. That is, the number of surrounding signals having fail values is greater than or equal to half the total number of the surrounding signals. Therefore, the second detection result indicating that the fail value of the third signal is fraudulent is derived. In this manner, if most of the surrounding signals have fail values, it is estimated that the fail value of the target signal or the fail values of all of the signals including the target signal may have fraudulent data disguised as fail values, and thus the target signal is determined as being fraudulent.

As described above, the control unit 20 of the in-vehicle apparatus 2 corrects the first detection result of the fail value of the detection target signal in accordance with the surrounding signals included in the same frame. This makes it possible to prevent erroneous detection that the fail value is fraudulent and to detect fraud disguised as a fail value, thereby properly executing the fail-safe process.

The control unit 20 may not necessarily determine that the detection target signal is normal if less than half of the surrounding signals have fail values. For example, the control unit 20 may determine that the detection target signal is normal if the number of surrounding signals having fail values is smaller than or equal to half the total number of surrounding signals. The control unit 20 may determine that the detection target signal is normal if the number of surrounding signals having fail values is less than a predetermined value.

The second detection process is not limited to a process of determining whether the message including the target signal is fraudulent based on all of the surrounding signals included in the message. For example, a plurality of signals selected from among all of the signals included in the same message in accordance with a predetermined standard may be set as surrounding signals. In this case, the control unit 20 may store, in advance, the correlation between the target signal and each surrounding signal and may select surrounding signals with higher correlation on a priority basis. Selecting surrounding signals for determination as appropriate makes it possible to perform a process in a more efficient manner.

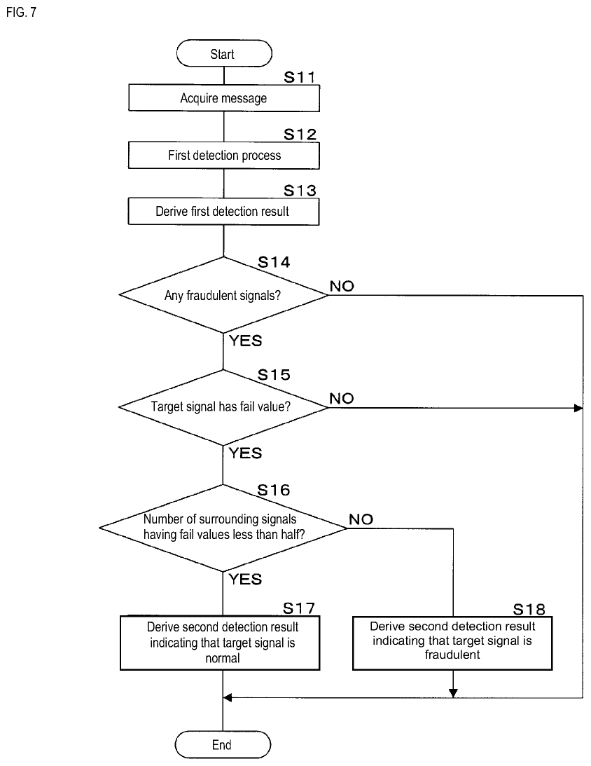

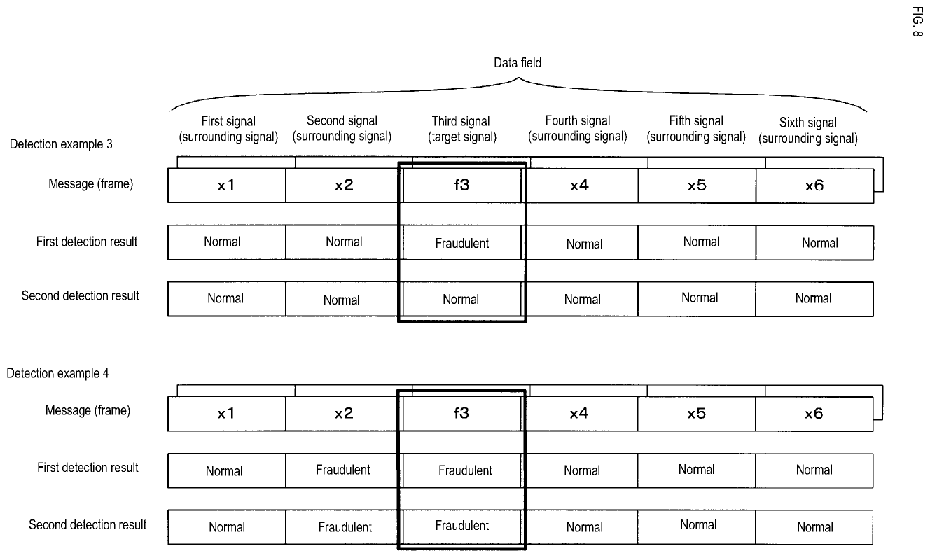

FIG. 7 is a flowchart of a procedure of a detection process executed by the in-vehicle apparatus 2 in the first embodiment. The control unit 20 of the in-vehicle apparatus 2 executes the following process in accordance with a program 21P stored in the storage unit 21. The control unit 20 performs the following process constantly while the vehicle 1 is running, for example.

The control unit 20 of the in-vehicle apparatus 2 acquires a message (step S11). The control unit 20 receives and acquires the message transmitted from any of the ECUs 3 via the in-vehicle communication unit 23. The message includes a plurality of signals, that is, a target signal and surrounding signals other than the target signal. The control unit 20 stores the acquired message in the storage unit 21.

The control unit 20 executes the first detection process to detect whether the acquired message is fraudulent (step S12), and derives the first detection result indicating whether each signal included in the message is normal or fraudulent (step S13). Specifically, from among the plurality of messages stored in a time-series manner in the storage unit 21, the control unit 20 specifies a previously received message including the same kind of data as the currently acquired message, based on the message identifier, for example. The control unit 20 calculates the amount of change in each signal per unit time, based on the difference between each signal in the current message and the corresponding signal in the previous message. The control unit 20 determines whether each signal is normal or fraudulent based on whether or not the amount of change in each signal falls within a prescribed normal range, and derives the determination result as the first detection result.

The control unit 20 determines whether the acquired message includes a signal detected as being fraudulent, based on the first detection result of the plurality of signals included in the message (step S14). If the control unit 20 determines that the acquired message does not include a signal detected as being fraudulent (S14: NO), the control unit 20 sets the first detection result as the detection result of the message, and ends the message reception process. If the control unit 20 determines that the acquired message includes a signal detected as being fraudulent (S14: YES), the control unit 20 moves to step S15. The control unit 20 may determine in step S14 whether or not the acquired message includes a target signal detected as being fraudulent. That is, the control unit 20 may execute step S15 and subsequent steps only if the target signal included in the message is detected as being fraudulent in the first detection process.

The control unit 20 refers to the fail value DB 211 to determine whether or not the target signal included in the message has a fail value (step S15). If the control unit 20 determines that the target signal does not have a fail value because there is no match between any of the fail values stored in the fail value DB 211 and the target signal (S15: NO), the control unit 20 sets the first detection result as the detection result of the message, and ends the message reception process.

If the control unit 20 determines that the target signal has a fail value because there is a match between one of the fail values stored in the fail value DB 211 and the target signal (S15: YES), the control unit 20 advances to the second detection process. The control unit 20 determines whether or not the number of surrounding signals having fail values is smaller than half the total number of surrounding signals, by determining whether each of the surrounding signals included in the message has a fail value (step S16). The control unit 20 may collectively acquire the determination results indicating whether all of the signals included in the message have fail values through one determination process.

If the control unit 20 determines that the number of surrounding signals having fail values is smaller than half the total number of surrounding signals (S16: YES), the control unit 20 derives a second determination result indicating that the target signal is normal (step S17). If the control unit 20 determines that the number of surrounding signals having fail values is not smaller than half the total number of the surrounding signals (S16: NO), the control unit 20 derives a second detection result indicating that the target signal is fraudulent (step S18). The control unit 20 sets the second detection result in step S17 or S18 as the detection result of the message, and ends the message reception process. Steps S16 to S18 correspond to the second detection process.

In the foregoing process, the control unit 20 may perform a loop process to execute again step S11. The control unit 20 may perform a loop process to execute step S15 again, and then may perform the second detection process on a different signal included in the same message as a new target signal.

In the above-described process, if the control unit 20 acquires a detection result indicating that a signal included in a message is fraudulent, the control unit 20 preferably executes a prevention process such as stopping the relay of the message or blocking communication in accordance with the detection result.

According to the present embodiment, even if a message transmitted to the in-vehicle network 40 includes a fail value, the information regarding signals other than the signal having the fail value is used to accurately detect fraud

### Second Embodiment

In a second embodiment, details of detection and determination in a second detection process are different from those of the first embodiment. Thus, the differences will be mainly described below. The other configurations in the second embodiment are similar to those in the first embodiment, and thus common components are denoted with identical reference signs and detailed description thereof will be omitted.

If a target signal included in a message has a fail value, the control unit 20 of the in-vehicle apparatus 2 in the second embodiment determines whether or not the target signal is normal based on a first detection result of surrounding signals included in the same message. If the first detection result indicates that the surrounding signals are all normal, the control unit 20 determines that the target signal is normal. If the first detection result indicates that not all of the surrounding signals are normal, that is, if the first detection result indicates that at least one of the surrounding signals is fraudulent, the control unit 20 determines that the target signal is fraudulent.

FIG. 8 is a conceptual diagram showing first detection results and second detection results in the second embodiment. Using FIG. 8, a second detection process in the second embodiment will be described in detail in reference to a detection example 3 and a detection example 4. In FIG. 8, an example is described in which the data field of a message (frame) includes first to sixth signals, a total of six signals, and the third signal is a vehicle speed signal that is the detection target signal.

In the detection example 3 on the upper side of FIG. 8, the third signal in the current message has a fail value. The five surrounding signals other than the third signal each have valid values. The first detection result indicating that the third signal is fraudulent and the surrounding signals are all normal is derived.

The control unit 20 executes the second detection process to determine whether or not the fail value of the third signal is fraudulent based on the first detection result of the surrounding signals. In the detection example 3, the first detection result indicates that the surrounding signals are all normal. Therefore, the second detection result indicating that the fail value of the third signal is normal is derived. In this manner, if the surrounding signals are normal, it is determined that the target signal has normal data, and the change in the signal value resulting from the fail value is proper, and thus the target signal is determined as being normal.

In the detection example 4 on the lower side of FIG. 8, the third signal in the current message has a fail value. The five surrounding signals other than the third signal each have valid values. The first detection result indicating that the third signal is fraudulent is derived. In addition, the detection result indicating that, among the surrounding signals, the second signal is fraudulent, and the first, fourth, fifth, and sixth signals are normal is derived. In this case, since the first detection result indicates that one of the surrounding signals is fraudulent, the control unit 20 derives the second detection result indicating that the fail value of the third signal is fraudulent. In this manner, if any of the surrounding signals is fraudulent, it is estimated that the fail value of the target signal may also be fraudulent, and thus the target signal is determined as being fraudulent.

In the above-described process, the control unit 20 may not necessarily determine that the detection target signal is normal if the first detection result indicates that all of the surrounding signals are normal. For example, the control unit 20 may determine that the detection target signal is normal if the number of surrounding signals indicated as being normal in the first detection result is greater than or equal to a predetermined value.

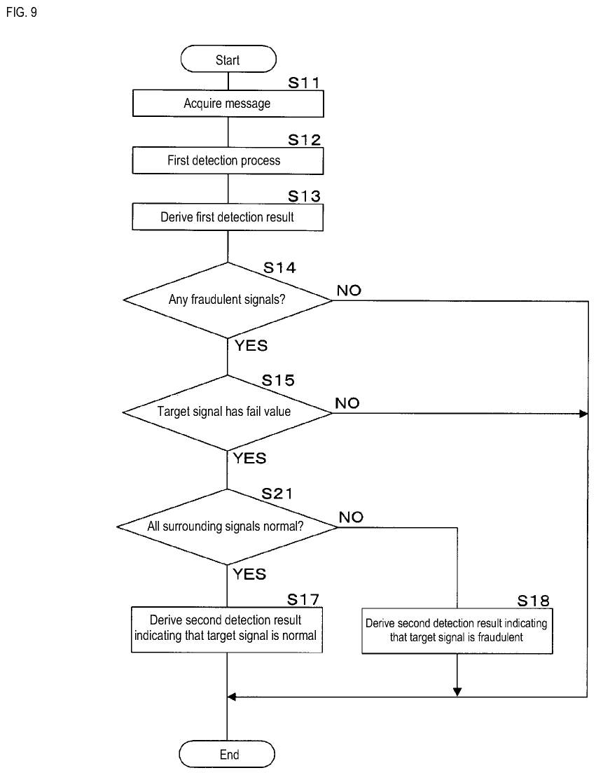

FIG. 9 is a flowchart of a procedure of a detection process executed by the in-vehicle apparatus 2 in the second embodiment. The steps in common with those in the first embodiment described in FIG. 7 are denoted with identical step numbers and detailed description thereof will be omitted.

The control unit 20 of the in-vehicle apparatus 2 acquires a message (step S11). The control unit 20 executes the first detection process to detect whether the acquired message is fraudulent (step S12), and derives the first detection result indicating that the signals included in the message are normal or fraudulent (step S13).

Based on the first detection result of the plurality of signals included in the message, the control unit 20 determines whether or not the acquired message includes a signal detected as being fraudulent (step S14). If the control unit 20 determines that the acquired message does not include a signal detected as being fraudulent (S14: NO), the control unit 20 sets the first detection result as the detection result of the message, and ends the message reception process. If the control unit 20 determines that the acquired message includes a signal detected as being fraudulent (S14: YES), the control unit 20 advances to step S15.

The control unit 20 refers to the fail value DB 211 to determine whether or not the target signal included in the message has a fail value (step S15). If the control unit 20 determines that the target signal does not have a fail value (S15: NO), the control unit 20 sets the first detection result as the detection result of the message, and ends the message reception process.

If the control unit 20 determines that the target signal has a fail value (S15: YES), the control unit 20 advances to the second detection process. The control unit 20 determines whether or not the first detection result indicates that the surrounding signals included in the message are all normal (step S21).

If the control unit 20 determines that the first detection result indicates that the surrounding signals are all normal (S21: YES), the control unit 20 derives the second detection result indicating that the target signal is normal (step S17). If the control unit 20 determines that the first detection result indicates that not all of the surrounding signals are normal (S21: NO), the control unit 20 derives the second detection result indicating that the target signal is fraudulent (step S18). The control unit 20 sets the second detection result in step S17 or step S18 as the detection result of the message, and ends the message reception process. Steps S16 to S18 correspond to the second detection process.

According to the present embodiment, even if a message transmitted to the in-vehicle network 40 includes a fail value, the first detection result of signals other than the signal including the fail value can be used to accurately detect fraud.

### Third Embodiment

A third embodiment is different from the first embodiment in that a second detection process is performed on the message including a target signal based on another message, and thus the difference will be mainly described below. The other configurations in the third embodiment are similar to those in the first embodiment, and thus common components are denoted with identical reference signs and detailed description thereof will be omitted.

The control unit 20 of the in-vehicle apparatus 2 in the third embodiment determines whether or not the target signal is normal based on signals in a message other than the message including the target signal. For example, the message including the target message is transmitted from the ECU 3 connected to the communication line 41 to the in-vehicle apparatus 2 via the communication line 41. If the target signal included in the acquired message has a fail value, the control unit 20 of the in-vehicle apparatus 2 determines whether or not the target signal is normal based on the message including the target signal and signals in other messages transmitted via the communication line 41.

The control unit 20 acquires the message including the fail value, and specifies another message transmitted via the communication line 41 through which the message including the fail value was transmitted, in a predetermined period around the time of acquisition of the message including the fail value. The control unit 20 acquires the number of signals having fail values, for example, among the signals in the specified other message. The control unit 20 calculates the total sum of the number of signals having fail values in the acquired other message and the number of surrounding signals having fail values in the message including the target signal. The control unit 20 executes the second detection process to determine whether or not the target signal is normal, based on whether or not the calculated total sum is smaller than half the total number of the signals in the other message and the surrounding signals in the message including the target signal. The control unit 20 may execute the second detection process to determine whether or not the target signal is normal based on the first detection result of the signals included in the other message.

According to the present embodiment, detecting fraudulence on a bus-by-bus basis increases the detection accuracy more than the case of determining fraudulence on a message-by-message basis.

It should be noted that the embodiments disclosed herein are examples in all respects and are not limitative. The technical features described in relation to the embodiments can be combined with each other. The present disclosure is intended to include all modifications within a meaning and scope equivalent to the scope of claims.

1. An in-vehicle apparatus that is mounted in a vehicle and detects fraudulence in a message transmitted by an in-vehicle network, the in-vehicle apparatus comprising a control unit that controls a process related to detection of fraudulence in the message,
wherein the control unit provisionally detects whether a plurality of signals included in the acquired message are fraudulent,
determines whether or not a target signal out of the plurality of signals including a signal provisionally detected as being fraudulent has a fail value, and
if the target signal has the fail value, the control unit detects whether the target signal included in the message is fraudulent, based on the signals other than the target signal out of the plurality of signals included in the message.

2. The in-vehicle apparatus according to claim 1,
wherein the in-vehicle apparatus determines whether each of the signals other than the target signal has the fail value, and if the number of signals having the fail value other than the target signal is less than a first predetermined value, the in-vehicle apparatus detects the target signal as being normal.

3. The in-vehicle apparatus according to claim 1, wherein the in-vehicle apparatus determines whether each of the signals other than the target signal has the fail value, and if the number of signals having the fail value other than the target signal is less than half the total number of the signals other than the target signal, the in-vehicle apparatus detects the target signal as being normal.

4. The in-vehicle apparatus according to claim 1, wherein the in-vehicle apparatus provisionally detects whether the plurality of signals are fraudulent to detect the target signal as being normal if the number of signals provisionally detected as being normal out of the plurality of signals is greater than or equal to a second predetermined value.

5. The in-vehicle apparatus according to claim 1, wherein the in-vehicle apparatus provisionally detects whether the plurality of signals are fraudulent to detect the target signal as being normal if the in-vehicle apparatus acquires a provisional detection result indicating that all of the signals other than the target signal out of the plurality of signals are normal.

6. The in-vehicle apparatus according to claim 1,
wherein the in-vehicle network is provided with a plurality of communication lines, and
if the target signal included in the message transmitted via any one of the plurality of communication lines has the fail value, the in-vehicle apparatus detects whether the target signal in the message is fraudulent based on a signal in another message transmitted via the any one of the communication lines.

7. The in-vehicle apparatus according to claim 1, wherein the fail value is a value for executing a predetermined fail-safe process.

8. The in-vehicle apparatus according to claim 1, wherein the message is in conformity with Controller Area Network (CAN) protocol.

9. The in-vehicle apparatus according to claim 1, wherein the in-vehicle apparatus refers to a table storing fail values by signal type to determine whether or not the target signal has the fail value.

10. The in-vehicle apparatus according to claim 1, wherein the in-vehicle apparatus detects whether the target signal is fraudulent, based on a signal other than the target signal out of the plurality of signals included in the message and is selected in accordance with a correlation with the target signal.

11. A fraud detection method comprising:
provisionally detecting whether a plurality of signals included in an acquired message transmitted to an in-vehicle network are fraudulent,
determining whether a target signal out of the plurality of signals including a signal provisionally detected as being fraudulent has a fail value, and
if the target signal has the fail value, detecting whether the target signal included in the message is fraudulent, based on the signals other than the target signal out of the plurality of signals included in the message.

12. A computer program causing a computer to execute:
provisionally detecting whether a plurality of signals included in an acquired message transmitted to an in-vehicle network are fraudulent,
determining whether a target signal out of the plurality of signals including a signal provisionally detected as being fraudulent has a fail value, and
if the target signal has the fail value, detecting whether the target signal included in the message is fraudulent, based on the signals other than the target signal out of the plurality of signals included in the message.
